(19) United States
(12) Patent Application Publication
(10) Pub. No.: US 2023/0001908 A1
(43) Pub. Date: Jan. 5, 2023

(54) APPARATUS AND METHOD FOR REDUNDANT CONTROL OF A HYDRAULIC BRAKE SYSTEM

(71) Applicants: ZF Active Safety US Inc, Livonia, MI (US); ZF Active Safety GmbH, Koblenz (DE)

(72) Inventors: FRANK EINIG, OCHTENDUNG (DE); BLAISE J. GANZEL, ANN ARBOR, MI (US); NICHOLAS ALFORD, WALDESCH (DE)

(21) Appl. No.: 17/366,623

(22) Filed: Jul. 2, 2021

(51) Int. Cl. B60T 13/74; B60T 13/68; B60T 13/14; B60T 17/22; B60T 7/04; B60T 7/06

(52) U.S. Cl. CPC B60T 13/745; B60T 13/686; B60T 13/142; B60T 17/222; B60T 7/042; B60T 7/06; B60T 2270/413

(57) ABSTRACT

A brake system for selectively actuating at least one of a pair of front wheel brakes and a pair of rear wheel brakes includes a reservoir and a power transmission unit configured for selectively providing pressurized hydraulic fluid for actuating at least a selected one of the wheel brakes during a braking event. The power transmission unit includes an electric motor for selectively actuating a fluid pressurization cycle. The electric motor is a dual-wound electric motor having first and second windings. A first electronic control unit is provided for selectively controlling the first windings of the electric motor of the power transmission unit. A second electronic control unit is provided for selectively controlling the second windings of the electric motor of the power transmission unit. An isolation valve and a dump valve are associated with each wheel brake.

### TECHNICAL FIELD

This disclosure relates to an apparatus and method for redundant control of a hydraulic brake system and, more particularly, to a method and apparatus of selectively actuating at least one of a pair of front wheel brakes and a pair of rear wheel brakes in a brake system.

### BACKGROUND

A brake system may include a plurality of wheel brakes and a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include an electronic control unit that can be used to provide a braking command to the wheel brakes, autonomously and/or manually (e.g., via the use of an operator-manipulable brake pedal).

### SUMMARY

In an aspect, a brake system for selectively actuating at least one of a pair of front wheel brakes and a pair of rear wheel brakes is disclosed. The system includes a reservoir and a power transmission unit configured for selectively providing pressurized hydraulic fluid for actuating at least a selected one of the wheel brakes during a braking event. The power transmission unit includes an electric motor for selectively actuating a fluid pressurization cycle. The electric motor is a dual-wound electric motor having first and second windings. A first electronic control unit is provided for selectively controlling the first windings of the electric motor of the power transmission unit. A second electronic control unit is provided for selectively controlling the second windings of the electric motor of the power transmission unit. An isolation valve and a dump valve are associated with each wheel brake. The isolation valve is located hydraulically between a respective wheel brake and the power transmission unit. The dump valve is located hydraulically between a respective wheel brake and the reservoir, for the corresponding wheel brake.

### BRIEF DESCRIPTION OF THE DRAWINGS

For a better understanding, reference may be made to the accompanying drawings, in which:

FIG. 1 is a schematic hydraulic diagram of a brake system according to an aspect of the present invention, in a first configuration; and

FIG. 2 is a schematic hydraulic diagram of a brake system according to an aspect of the present invention, in a second configuration.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

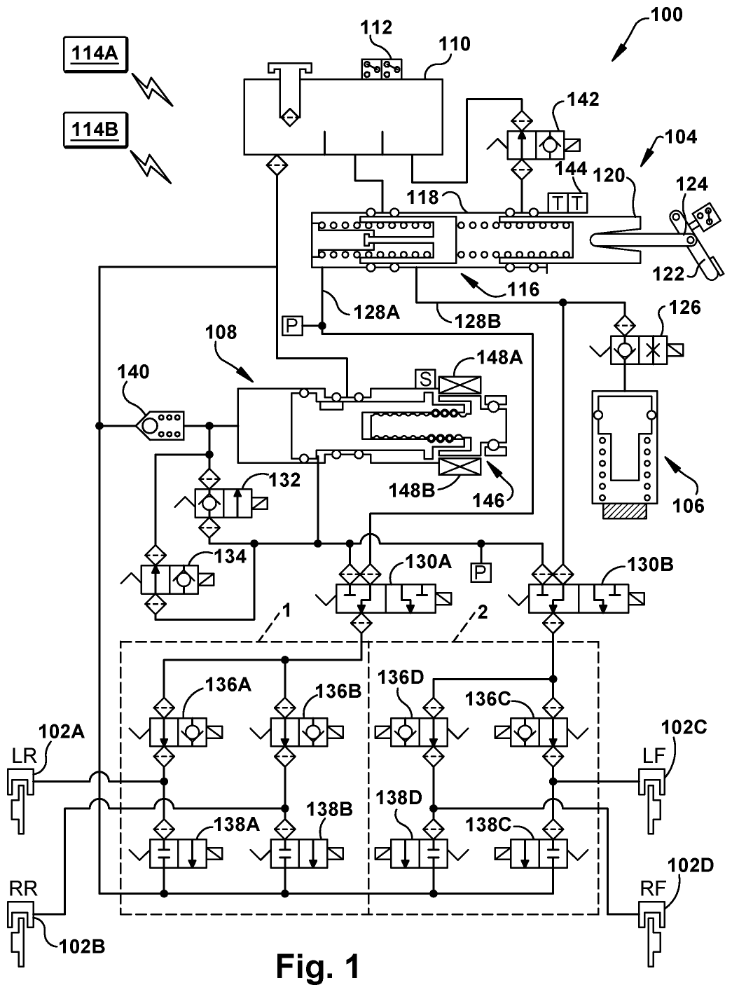

FIG. 1 depicts a brake system 100 for actuating a pair of front wheel brakes and a pair of rear wheel brakes, in a first configuration. The brake system 100 is shown in FIG. 1 as a hydraulic brake by wire system in which electronically controlled fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The block or housing may be made from solid material, such as aluminum, that has been drilled, machined, or otherwise formed to house the various components. Fluid conduits may also be formed in the block or housing.

In the illustrated embodiment of the brake system 100, there are four wheel brakes 102A, 102B, 102C, and 102D. The wheel brakes 102A, 102B, 102C, and 102D can have any suitable wheel brake structure operated electrically and/or by the application of pressurized brake fluid. Each of the wheel brakes 102A, 102B, 102C, and 102D may include, for example, a brake caliper mounted on the vehicle to engage a frictional element (such as a brake disc) that rotates with a vehicle wheel to effect braking of the associated vehicle wheel. The wheel brakes 102A, 102B, 102C, and 102D can be associated with any combination of front and rear wheels of the vehicle in which the brake system 100 is installed. For example, the brake system 100 may be configured as a front/rear split system, as shown, such that a first pressure circuit (indicated by dashed line “1” in FIG. 1) is associated with providing fluid to one or both of the rear wheel brakes 102A and 102B A second pressure circuit (indicated by dashed line “2” in FIG. 1) may be associated with providing fluid to one or both of the front wheel brakes 102C and 102D It is contemplated that any of the wheel brakes 102 referenced herein as being hydraulically operated may also or instead be electrically operated, such as by including at least one rear wheel brake motor (not shown) for selectively electrically actuating parking and/or service brakes, for some use environments of the brake system 100.

In this example, the wheel brake 102A may be associated with a left rear wheel of the vehicle in which the brake system 100 is installed, and the wheel brake 102B may be associated with the right rear wheel. The wheel brake 102C may be associated with the left front wheel, and the wheel brake 102D may be associated with the right front wheel. Alternatively, though not depicted here, the brake system 100 may be configured as a diagonal split brake system such that the wheel brakes 102A and 102B are associated with wheels at two diagonal corners of the vehicle, and the wheel brakes 102C and 102D are associated with wheels on the other two diagonal corners of the vehicle.

The brake system 100 generally includes a brake pedal unit, indicated generally at 104, a pedal simulator, indicated generally at 106, a power transmission unit (also known as a dual acting plunger (“DAP”) or a plunger assembly in some configurations), indicated generally at 108, and a fluid reservoir 110. The reservoir 110 stores and holds hydraulic fluid for the brake system 100. The fluid within the reservoir 110 is preferably held at or about atmospheric pressure, but the fluid may be stored at other pressures if desired. The reservoir 110 is shown schematically having three tanks or sections with fluid conduit lines connected thereto. The sections can be separated by several interior walls within the reservoir 110 and are provided to prevent complete drainage of the reservoir 110 in case one of the sections is depleted due to a leakage via one or more of the three lines connected to the reservoir 110. Alternatively, the reservoir 110 may include multiple separate housings. The reservoir 110 may include at least one fluid level sensor 112 (two shown, for redundancy) for detecting the fluid level of one or more of the sections of the reservoir 110.

The power transmission unit 108 of the brake system 100 functions as a source of pressure to provide a desired pressure level to the wheel brakes 102A, 102B, 102C, and 102D during a typical or normal non-failure brake apply. After a brake apply, fluid from the hydraulically operated ones of the wheel brakes 102A, 102B, 102C, and 102D may be returned to the power transmission unit 108 and/or diverted to the reservoir 110. In the depicted embodiment, the power transmission unit 108 is a dual acting plunger assembly which is configured to also provide boosted pressure to the brake system 100 when a piston of the power transmission unit 108 is stroked rearwardly as well as forwardly. It is also contemplated that a configuration (not shown) of the brake system 100 could include hydraulic control of only two wheels, with the remaining wheels being electrically controlled/actuated. One of ordinary skill in the art would be readily able to provide such an arrangement for a desired use environment, following aspects of the present invention.

Regardless of specific configuration, though, the power transmission unit 108 is configured for selectively providing pressurized hydraulic fluid for actuating at least a selected one of the wheel brakes 102 in a boosted braking mode during a braking event.

The brake system 100 also includes at least one electronic control unit (“ECU”) 114. As shown and described herein, two separate ECUs 114A, 114B are provided, for redundancy. Each ECU 114 may include microprocessors and other electrical circuitry. Each ECU 114 receives various signals, processes signals, and controls the operation of various electrical components of the brake system 100 in response to the received signals. Each ECU 114 can be connected to various sensors such as the reservoir fluid level sensor 112, pressure sensors, travel sensors, switches, wheel speed sensors, and steering angle sensors. Each ECU 114 may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, each ECU 114 may be connected to the instrument cluster for collecting and supplying information related to warning indicators such as an ABS warning light, a brake fluid level warning light, and a traction control/vehicle stability control indicator light. The electronic control units 114A, 114B are provided, in the configuration of the brake system 100 shown in FIG. 1, for controlling at least one of the power transmission unit 108 and the first and second pressure circuits.

As shown schematically in FIG. 1, the brake pedal unit 104 includes a master cylinder 116 with a housing 118 for slidably receiving various cylindrical pistons and other components therein. Note that the housing is not specifically schematically shown in the Figures, but instead the walls of the longitudinally extending bore are schematically illustrated. The housing 118 may be formed as a single unit or include two or more separately formed portions coupled together. An input piston 120 is connected with a brake pedal 122 via a linkage arm 124. Leftward movement of the input piston 120 may cause, under certain conditions, a pressure increase within the master cylinder 116. In the brake system 100 shown in FIG. 1, the master cylinder 116 can be used to provide a manual push through mode, during predetermined phases of operation of the brake system 100, on a routine and/or acute event basis.

The brake pedal unit 104 is connected to the brake pedal 122 and is actuated by the driver of the vehicle as the driver presses on the brake pedal 122. A brake sensor or switch 144 may be electrically connected to the ECU 114 to provide a signal indicating a depression of the brake pedal 122. The pedal simulator 106, when present, provides a comfortable and expected “feel” to the brake pedal 122 motion for the driver and is hydraulically connected to the master cylinder 116 via pedal simulator valve 126.

The brake pedal unit 104 may be used as a back-up source of pressurized fluid to essentially replace the normally supplied source of pressurized fluid from the power transmission unit 108 under certain failed conditions of the brake system 100, and/or upon initial startup of the brake system 100. This situation is referred to as a manual push-through event, or a “manual apply”. In the brake system 100 shown in FIG. 1, manual push-through may be accomplished for one pair of wheel brakes 102 only (usually for the pair of front wheel brakes 102C, 102D for vehicle weight distribution and weight transfer during braking reasons), or for all four wheel brakes 102 (i.e., the pair of front wheel brakes 102C, 102D and the pair of rear wheel brakes 102A, 102B).

The brake pedal unit 104 can supply pressurized fluid to a master cylinder output 128, which is then routed to the hydraulically operated ones of the wheel brakes 102A, 102B, 102C, and 102D as desired. In the brake system 100 shown in FIG. 1, two master cylinder outputs 128A, 128B are provided, for supplying push through hydraulic pressure to the first and second pressure circuits, respectively. This flow is pushed through, largely under mechanical pressure upon the brake pedal 122 from the driver's foot, from the master cylinder 116. That is, the master cylinder 116 is operable during a manual push-through mode by actuation of the brake pedal 122 connected to the master cylinder 116 to generate brake actuating pressure at first and second outputs 128A, 128B for hydraulically actuating at least a selected one of a pair of front wheel brakes 102C, 102D and a pair of rear wheel brakes 102A, 102B during the manual push-through mode.

A power transmission unit 108 is configured for selectively providing pressurized hydraulic fluid for actuating the pair of front wheel brakes 102C and 102D and the pair of rear wheel brakes 102A and 102B during a braking event. A two-position three-way valve 130 is hydraulically connected with the master cylinder 116 and the power transmission unit 108 and, as shown in FIG. 1, with a selected pair of the rear wheel brakes 102A, 102B or the front wheel brakes 102C and 102D. As shown in FIG. 1, first and second three-way valves 130A, 130B are provided, for actuation of the first and second pressure circuits, respectively. The three-way valves 130A, 130B selectively control hydraulic fluid flow from a chosen one of the master cylinder 116 and the power transmission unit 108 to a respective one of the pair of front wheel brakes 102B and 102D and the pair of rear wheel brakes 102A and 102C.

Through use of the three-way valves 130A, 130B, hydraulic fluid can be routed to the respective pair of front wheel brakes 102C/102D and/or rear wheel brakes 102A/102B in a desired manner (from a chosen one of the master cylinder 116 or the power transmission unit 108) to assist with boosted braking control and provide desired response times and efficient pressure flow to the wheel brakes 102 stated differently, the three-way valves 130A, 130B are configured to selectively switch the brake system 100 between manual push-through mode and boosted braking mode.

A normally-closed dual-acting plunger (“DAP”) valve 132 and a normally-open DAP valve 134 are located fluidically between the power transmission unit 108 and at least one of the three-way valves 130A, 130B.

An isolation valve 136 and a dump valve 138 are associated with each wheel brake of the pair of front wheel brakes 102C, 102D and the pair of rear wheel brakes 102A, 102B. (The isolation valves 136 and dump valves 138 are labeled in the Figures with a suffixed “A”, “B”, “C”, or “D” to indicate the corresponding one of the wheel brakes 102 with which each is associated). The isolation valves 136 are located hydraulically between their respective wheel brake 102 and the power transmission unit 108, and specifically as shown in FIG. 1, between their respective wheel brake 102 and the respective three-way valve 130A, 130B. The dump valves 138 are located hydraulically between their respective wheel brake 102 and the reservoir 110.

FIG. 1 also depicts a replenishing check valve 140, which is located fluidically between the reservoir 110 and the power transmission unit 108. When present, the replenishing check valve 140 may be provided to assist with refilling of the power transmission unit 108 (or components thereof) under predetermined conditions. For example, the replenishing check valve 148 may help to facilitate refilling of the chamber in front of the DAP head when the DAP-type power transmission unit 108 is building pressure during its retraction stroke (normally closed DAP valve de-energized and normally open DAP valve energized) by pushing fluid out of the annular chamber behind the DAP head. This is done, for example, during slip control if additional flow to the brakes is needed after the DAP is stroked fully forward.

A simulator test valve 142 may be provided between the brake pedal unit 104 and the reservoir 110.

As mentioned above, the brake pedal 122 is connected to the brake pedal unit 104 and selectively actuated by a driver of the vehicle to indicate a desired braking command. The brake pedal unit 104 includes a travel sensor 144 (here, a redundant travel sensor) for determining a position of the brake pedal 122 and responsively producing a braking signal corresponding to the desired braking command. (One or more pressure sensors elsewhere in the brake system 100 could also or instead be used to measure or infer brake pedal force, such as, but not limited to, a pressure sensor [not shown] operatively coupled to a portion of the master cylinder 116.) As previously mentioned, first and second ECUs 114A, 114B are provided to the brake system 100 depicted in FIG. 1, for redundancy. In this brake system 100, the power transmission unit 108 includes an electric motor 146 for selectively actuating a fluid pressurization cycle of the power transmission unit 108. Here, the electric motor 146 is a dual-wound electric motor having first and second windings, depicted schematically at 148A and 148B of FIG. 1. The first ECU 114A selectively controls the first windings 148A of the electric motor 146 of the power transmission unit 108. The second ECU 114B selectively controls the second windings 148B of the electric motor 146 of the power transmission unit 108.

It will be understood by one of ordinary skill in the art that the “first and second windings”, as referenced herein, could each include one or more individual windings. For example, an example implementation of the brake system 100 may include a “dual wound” electric motor 146 including two or more integrated three phase brushless DC motors. Each phase uses multiple windings that are connected together, typically via a lead frame with bus bars but other connection schemes are contemplated. For brevity and completeness, the “first windings” or “second windings”, as referenced herein, respectively encompasses a “first winding or set of windings” or “second winding or set of windings”, as desired for a particular use environment of the brake system 100.

Through use of a dual-wound electric motor such as that shown at 146—having any desired number of windings separated into the described first and second windings 148A and 148B, as just mentioned—a single power transmission unit 108 can be controlled by one or both of the ECUs 114A, 114B, thus facilitating use in a redundant “fault-tolerant” manner. That is, if one of the ECUs 114A, 114B were to fail, the other ECU 114A, 114B could still be used to control the respective windings 148 of the electric motor 146 and preserve the ability of the power transmission unit 108 to provide pressurized hydraulic fluid to the first and second pressure circuits. Accordingly, the braking signal is transmitted from the travel sensor 144 to at least one of the first and second electronic control units 114A, 114B, and the at least one of the first and second ECUs 114A, 114B controls a respective first and/or second windings 148A, 148B of the power transmission unit 108 responsive to the braking signal.

The braking signal may be transmitted wired or wirelessly to the first and/or second electronic control units 114A, 114B, and the first and second electronic control units 114A, 114B may in turn control any other components of the brake system 100 in a wired or wireless manner, with a wireless control by the ECUs 114A, 114B being depicted schematically in the Figures, for simplicity. It is contemplated that a selected one of the ECUs 114A, 114B could be a “master” ECU, as desired, with the other of the ECUs 114A, 114B providing a “backup” or “secondary” control of the brake system 100, or that both of the ECUs 114A, 114B could be used concurrently to control various parts of the brake system 100 during normal, non-failure operation.

In the brake system 100 shown in FIG. 1, one or more of the normally closed and normally open DAP valves 132, 134, the isolation valves 136, the dump valves 138, replenishing check valve 140, and/or the three-way valves 130 could also be of a dual-wound type, including first and second valve windings. When one or more of these or other system valves is of a dual-wound type, the first electronic control unit 114A may control the first valve windings and the second electronic control unit 114B may control the second valve windings, as desired for normal operation and/or emergency/redundancy purposes. To reduce cost and complexity in the brake system 100, it is contemplated that only a portion of the system valves may be of the dual-wound type, and instead the first ECU 114A could control some remaining subset of single-wound system valves (e.g., the isolation and dump valves 136, 138 of the first pressure circuit) while the second ECU 114B could control another remaining subset of single-wound system valves (e.g., the isolation and dump valve 136, 138 of the second pressure circuit). When single-wound system valves are provided, it will be understood that they may be configured to be normally open or normally closed in such a way to optimize performance of the brake system 100 even if one of the first and second ECUs 114A, 114B is intentionally or accidentally deactivated.

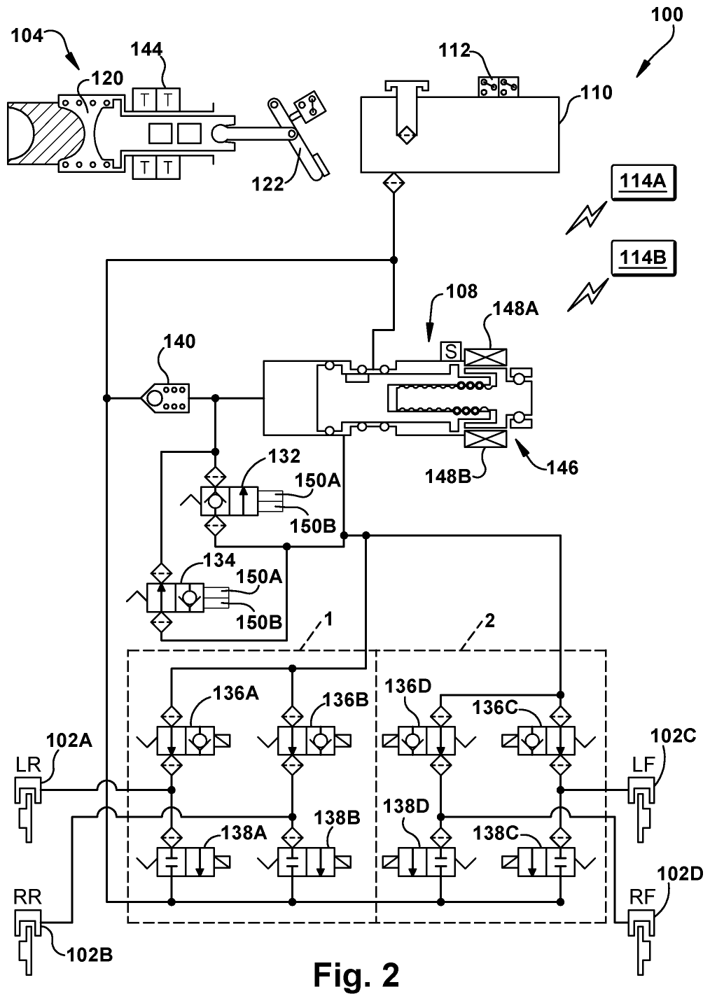

With reference now to FIG. 2, a second configuration of the brake system 100 is depicted, parts or all of which can be used with other components of the present invention, as desired. Description of similar components and operation which is made elsewhere in this application will not necessarily be repeated for each and every described configuration or aspect of the brake system 100, for brevity, but should instead be considered to apply to like-numbered portions of other configurations as appropriate.

In the arrangement of the brake system 100 shown in FIG. 2, the brake pedal unit 104 may be remotely located from other structures of the brake system 100, to provide a “brake by wire” configuration. Here, the brake pedal unit 104 is of a deceleration signal transmitter type, which provides the braking signal to the ECUs 114A, 114B in a wired or wireless manner exclusively. No manual push-through function is contemplated by the brake system 100 of FIG. 2. Accordingly, the master cylinder 116, three-way valves 130, and the pedal simulator 106 and related structures are omitted from the configuration shown in FIG. 2. It is contemplated that the brake pedal 122 and related structures may also be omitted from the brake system 100 shown in FIG. 2, for a truly autonomous brake arrangement (or simply a manually controlled brake arrangement using hand controls or another non-pedal input).

Again, the brake system 100 of FIG. 2 is substantially similar to that of FIG. 1, though somewhat simpler by virtue of being a “brake by wire” type. The brake system 100 of FIG. 2 includes normally closed and normally opened DAP valves 132, 134, isolation and dump valves 136, 138 for each of the wheel brakes 102, and a replenishing check valve 140. Again, first and second ECUs 114A, 114B are provided, with each ECU 114 controlling a respective one of the first and second windings 148A, 148B of the electric motor 146 of the DAP-type power transmission unit 108.

Also as referenced with respect to the brake system 100 of FIG. 1, the brake system 100 of FIG. 2 may include single- or dual-wound type normally closed and normally opened DAP valves 132, 134, isolation valves 136, dump valves 138, and/or replenishing check valves 140. As explicitly shown in FIG. 2, the normally closed and normally opened DAP valves 132, 134 are of the dual-winding type, with first windings 150A of each valve being controlled by the first ECU 114A and second windings 150B of each valve being cool controlled by the second ECU 114B.

In the brake systems 100 shown in both of FIGS. 1-2, redundancy is provided in the system through the use of one or more ECUs 114A, 114B, dual windings 148A, 148B of the electric motor 146 of the power transmission unit 108, and/or dual windings 150A, 150B of one or more of the system valves of the brake system 100. One of ordinary skill in the art can readily configure a brake system 100 according to the principles disclosed and taught herein for a particular use environment, as desired.

It is contemplated that components, arrangements, or any other aspects of the brake system 100 shown and described herein could also or instead be used (and vice versa) in the brake systems shown and depicted in co-pending patent applications U.S. patent application Ser. No. ______, filed concurrently herewith and titled “Apparatus and Method for Control of a Hydraulic Brake by Wire System” (attorney docket no. ZF(BEJ)-030485 US PRI), and/or U.S. patent application Ser. No. _____, filed concurrently herewith and titled “Apparatus and Method for Selectively Actuating Wheel Brakes of a Hydraulic Brake System” (attorney docket no. ZF(BEJ)-030486 US PRI), both of which are hereby incorporated by reference in their entirety for all purposes.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

What is claimed is:

1. A brake system for selectively actuating at least one of a pair of front wheel brakes and a pair of rear wheel brakes, the system comprising:
a reservoir;
a power transmission unit configured for selectively providing pressurized hydraulic fluid for actuating at least a selected one of the wheel brakes during a braking event, the power transmission unit including an electric motor for selectively actuating a fluid pressurization cycle, the electric motor being a dual-wound electric motor having first and second windings;
a first electronic control unit for selectively controlling the first winding of the electric motor of the power transmission unit;
a second electronic control unit for selectively controlling the second winding of the electric motor of the power transmission unit; and
an isolation valve and a dump valve associated with each wheel brake, the isolation valve being located hydraulically between a respective wheel brake and the power transmission unit, and the dump valve being located hydraulically between a respective wheel brake and the reservoir, for the corresponding wheel brake.

2. The brake system of claim 1, including a replenishing check valve, a normally open DAP valve, and a normally closed DAP valve located fluidically between the reservoir and the power transmission unit for assisting with refilling of the power transmission unit under predetermined conditions.

3. The brake system of claim 2, wherein the normally open and normally closed DAP valves are each of a dual-wound type, including first and second valve windings, wherein the first electronic control unit controls the first valve windings and the second electronic control unit controls the second valve windings.

4. The brake system of claim 2, wherein the isolation valves and dump valves are each of a dual-wound type, including first and second valve windings, wherein the first electronic control unit controls the first valve windings and the second electronic control unit controls the second valve windings.

5. The brake system of claim 1, including a brake pedal connected to a brake pedal unit and selectively actuated by a driver of the vehicle to indicate a desired braking command, the brake pedal unit having a travel sensor for determining a position of the brake pedal and responsively producing a braking signal corresponding to the desired braking command, the braking signal being transmitted to at least one of the first and second electronic control units, and the at least one of the first and second electronic control units controlling a respective first or second winding of the power transmission unit responsive to the braking signal.

6. The brake system of claim 5, wherein the braking signal is wirelessly transmitted to the at least one of the first and second electronic control units.

7. The brake system of claim 1, including:
a master cylinder operable during a manual push-through mode by actuation of a brake pedal connected to the master cylinder to generate brake actuating pressure at first and second outputs for hydraulically actuating at least a selected one of a pair of front wheel brakes and a pair of rear wheel brakes during the manual push-through mode;
first and second three-way valves selectively controlling hydraulic fluid flow from a chosen one of the master cylinder and the power transmission unit to respective ones of the pairs of wheel brakes; and
a replenishing check valve, a normally open DAP valve, and a normally closed DAP valve located fluidically between the reservoir and the power transmission unit for assisting with refilling of the power transmission unit under predetermined conditions;
wherein the isolation valve for each wheel brake is located hydraulically between a respective wheel brake and the three-way valve, and the dump valve for each wheel brake is located hydraulically between a respective wheel brake and the reservoir.

8. The brake system of claim 7, wherein each three-way valve is configured to selectively switch the brake system between manual push-through mode and the boosted braking mode.

9. The brake system of claim 7, including a simulator test valve located fluidically between the reservoir and the master cylinder.

10. The brake system of claim 7, wherein the normally open and normally closed DAP valves are each of a dual-wound type, including first and second valve windings, wherein the first electronic control unit controls the first valve windings and the second electronic control unit controls the second valve windings.

11. The brake system of claim 7, wherein the isolation valves and dump valves are each of a dual-wound type, including first and second valve windings, wherein the first electronic control unit controls the first valve windings and the second electronic control unit controls the second valve windings.

12. The brake system of claim 7, wherein the three-way valves are of a dual-wound type, including first and second valve windings, wherein the first electronic control unit controls the first valve windings and the second electronic control unit controls the second valve windings.
